(19) United States
(12) Patent Application Publication
(10) Pub. No.: US 2009/0172405 A1
(43) Pub. Date: Jul. 2, 2009

(54) AUDIO DATA PROCESSING APPARATUS AND AUDIO DATA PROCESSING METHOD

(75) Inventors: Yoshikazu Shiomi, Hamura-shi (JP); Takanobu Mukaide, Tachikawa-shi (JP); Kosuke Haruki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/248,480

(22) Filed: Oct. 9, 2008

(30) Foreign Application Priority Data
Dec. 27, 2007 (JP) 2007-338205

(51) Int. Cl. H04L 9/32

(52) U.S. Cl. 713/176

(57) ABSTRACT

According to one embodiment, an audio data processing apparatus of this invention comprises a decryption unit which selects audio data to be reproduced under copyright protection, an HDMI unit which outputs the audio data selected by the decryption unit in the form of a bitstream to an AV amplifier connected via a dedicated cable, and a system control unit which acquires specification identification data from the AV amplifier before the bitstream output of the audio data and recognizes a watermark detection function of the AV amplifier on the basis of the specification identification data.

### CROSS-REFERENCE TO RELATED APPLICATIONS

This application is based upon and claims the benefit of priority from Japanese Patent Application No. 2007-338205, filed Dec. 27, 2007, the entire contents of which are incorporated herein by reference.

### BACKGROUND

1. Field

One embodiment of the present invention relates to an audio data processing apparatus and an audio data processing method which process audio data including a watermark that enables a copyright holder to be identified.

2. Description of the Related Art

In recent years, the importance of copyright protection has been increasing as high-capacity optical disks, such as DVDs, have become widely used. The technique for limiting the transfer of content on the basis of the copyright protection information recorded on an optical disk is known (e.g., refer to Jpn. Pat. Appln. KOKAI Publication No. 2005-92943).

Presently, of the commercially-available HD DVD content, the application of a watermark, or an electronic watermark that enables a copyright holder to be identified, is under consideration for those protected by the high-capacity optical disk device copyright protection standard (AACS). In this connection, a DVD player capable of detecting a watermark and providing reproduction control on the basis of the detection result is being developed. The watermark has to be detected from the result of expanding audio data by PCM decoding.

Many of the existing DVD players are also compatible with digital audio output, such as the High-Definition Multimedia Interface (HDMI). In the future, a DVD player which is compatible only with an HDMI audio output and has no audio output terminal excluding HDMI terminals is expected to appear on the market.

When the watermark is detected with a DVD player compatible with HDMI digital audio outputs, even if compressed audio data is output in HDMI form, the audio data has to be decoded to detect a watermark. If an AV amplifier which has the function of detecting a watermark comes on the market, the DVD player has to decode the audio data because it is unknown if an external unit, such as an AV amplifier, actually connected to the DVD player has a watermark detection function. In this case, since a reduction in the load in processing audio data cannot be expected, this makes it difficult to construct an inexpensive system.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram schematically showing a DVD player according to an embodiment of the invention;

FIG. 2 is an exemplary diagram for explaining the nature of the communication between the DVD player and an AV amplifier with a watermark detection function in FIG. 1;

FIG. 3 is an exemplary for explaining the nature of the communication between the DVD player and an AV amplifier without a watermark detection function in FIG. 1; and

FIG. 4 is an exemplary flowchart of an audio output process carried out by a system control unit shown in FIG. 1.

### DETAILED DESCRIPTION

Various embodiments according to the invention will be described hereinafter with reference to the accompanying drawings.

According to one embodiment of the invention, there is provided an audio data processing apparatus comprising: a selection unit which selects audio data to be reproduced under copyright protection; a digital output interface unit which outputs the audio data selected by the selection unit in the form of a bitstream to an external device connected via a dedicated cable; and a control unit which acquires specification identification data from the external device before the bitstream output of the audio data and recognizes a watermark detection function of the external device on the basis of the specification identification data.

According to one embodiment of the invention, there is provided an audio data processing method of selecting audio data under copyright protection and causing a digital output interface unit to output the selected audio data in the form of a bitstream to an external device connected to the digital output interface unit via a dedicated cable, the audio data processing method comprising: acquiring specification identification data from the external device before the bitstream output of the audio data and recognizing a watermark detection function of the external device on the basis of the specification identification data.

With the audio data processing apparatus and the audio data processing method, specification identification data is acquired from the external device before the bitstream output of the audio data. Then, the watermark detection function of the external device is recognized on the basis of the specification identification data. Accordingly, since it can be left to the external device to perform decoding necessary to detect a watermark in outputting digital audio, an inexpensive system can be constructed easily by reducing the load in processing audio.

An embodiment according to the invention will be described hereinafter with reference to the accompanying drawings.

Hereinafter, a DVD player according to an embodiment of the invention will be explained.

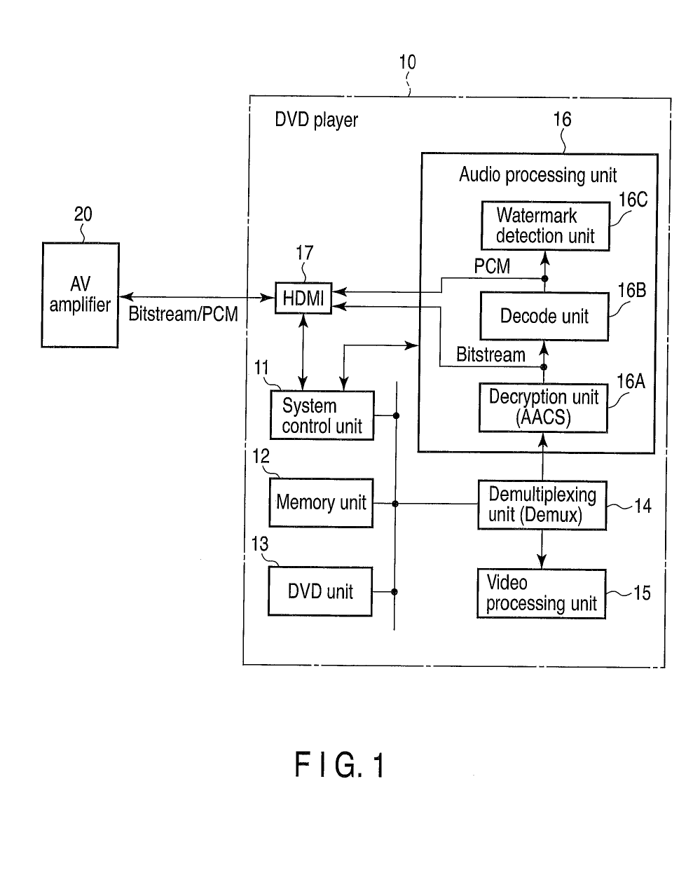

FIG. 1 schematically shows the configuration of the DVD player 10. The DVD player 10 comprises a system control unit 11, a memory unit 12, a DVD unit 13, a demultiplexing unit 14, a video processing unit 15, an audio processing unit 16, and an HDMI unit 17. The system control unit 11, which is connected to these components 12 to 17, controls these components 12 to 17 to perform the necessary control for the overall operation of the DVD player 10. The system control unit 11 includes, for example, a CPU for carrying out various processes, a ROM for holding a control program for the CPU and initial data, a RAM for temporarily holding the input and output data of the CPU, and a user interface for performing various setting input operations. The memory unit 12 is a buffer memory for the DVD unit 13. The DVD unit 13 reads content recorded in a DVD or an HD DVD into the memory unit 12. The system control unit 11 supplies the content in the memory unit 12 to the demultiplexing unit 14. The demultiplexing unit 14 separates the content into video data and audio data. A watermark is added to the result of separating the content of a commercially-available DVD or HD DVD. Then, the audio data is compressed by a compression method, such as DTS (a registered trademark), Dolby Digital (registered trademark), or MPEG audio, and then is encrypted as an object to be protected according to the copyright protection standard (AACS). On the other hand, in the result of separating the content of a user-produced DVD or HD DVD, the audio data sometimes has not been compressed or encrypted as an object to be protected according to the AACS. The video processing unit 15 converts video data output from the demultiplexing unit 14 into a format displayable on a display. The audio processing unit 16 converts audio data output from the demultiplexing unit into a format suitable for the input to, for example, the AV amplifier 20, an external device which provides a speaker output.

The audio processing unit 16 includes a decryption unit 16A for decrypting the encrypted audio data, a decode unit 16B for decoding the audio data output from the decryption unit 16A, and a watermark detection unit 16C for detecting a watermark from the audio data output from the decode unit 16B. Unencrypted audio data or audio data successfully decrypted is output from the decryption unit 16A to the decode unit 16B. In the decryption unit 16A, the audio data successfully decrypted is selected as audio data to be reproduced under copyright protection.

When the audio data obtained from the decryption unit 16A has been compressed, the AV amplifier 20 is compatible with the compression method and the detection of watermarks, and the user requests the output of bitstreams, the output of the decryption unit 16A is input to the HDMI unit 17. In this case, the DVD player 10 does not detect a watermark.

When the AV amplifier 20 is compatible with the compression method but is incompatible with watermark detection, the decode unit 16B carries out a decoding process and outputs the resulting audio data, or PCM data, to a watermark detection unit 16C. The watermark detection unit 16C detects a watermark. If the watermark detection unit 16C has detected an unauthorized watermark, the reproduction is stopped. If not, the result of processing at the decode unit 16B is input to the HDMI unit 17, which then outputs the data to the AV amplifier 20.

The system control unit 11 can control the processes performed at the decryption unit 16A, decode unit 16B, and watermark detection unit 16C. The HDMI unit 17 supplies the audio data from the decryption unit 16A and the audio data from the decode unit 16B as a bitstream output and a PCM output to the AV amplifier 20, respectively. The HDMI unit 17 informs the system control unit 11 that an external device (i.e., AV amplifier 20) is connected to the HDMI unit 17 with a dedicated cable (i.e., HDMI cable). As a result, the system control unit 11 recognizes the connection of the AV amplifier 20, acquires specification identification data (EDID) from the AV amplifier 20 before outputting an audio data bitstream, and recognizes at least the watermark detection function of the AV amplifier 20 from the specification identification data. When acquiring the EDID, the HDMI unit 17 is controlled so as to transmit an EDID request to the AV amplifier 20 via the Display Data Channel (DDC) protocol DDC line provided in the HDMI cable and receive an EDID sent back from the AV amplifier 20 via the DDC line in return to the request. The EDID has such a field configuration as can recognize the watermark detection function and the compatible audio data compression method.

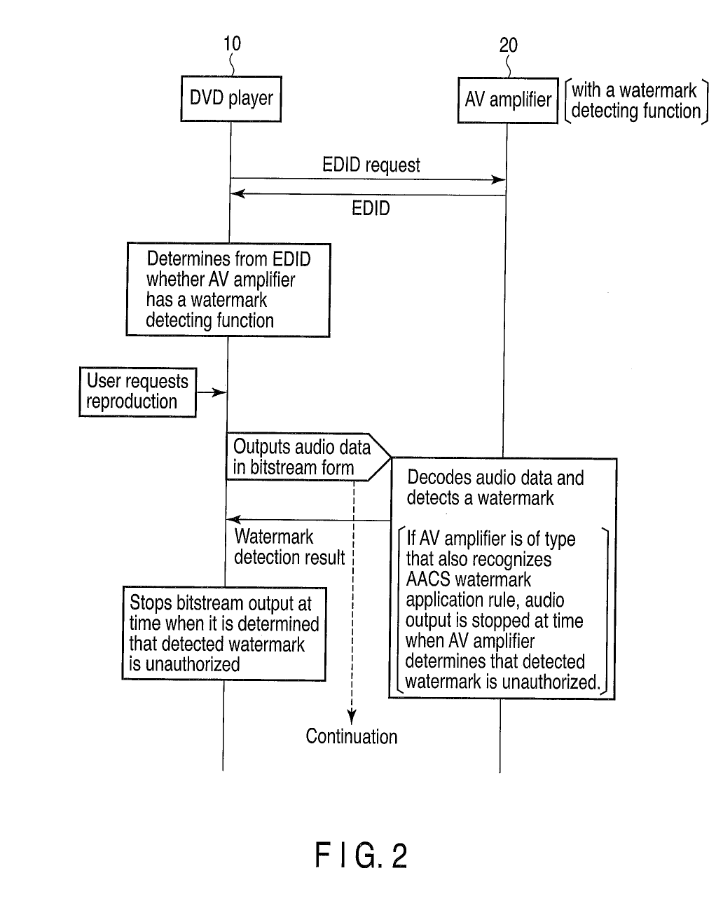

FIG. 2 shows the nature of the communication between the DVD player 10 and an AV amplifier 20 with a watermark detection function. When the AV amplifier 20 is connected to the DVD player with the HDMI cable, the DVD player 10 requests EDID from the AV amplifier 20, acquires EDID sent back from the AV amplifier 20 in return to the request, and determines from the EDID whether the AV amplifier 20 has a watermark detection function. When the user requests the reproduction of the audio data whose bitstream output has been selected after it has been determined that the AV amplifier 20 has a watermark detection function, the audio data is output from the DVD player 10 to the AV amplifier 20 in the form of a bitstream. Then, the AV amplifier 20 decodes the audio data output in bitstream form from the DVD player 10 as needed and detects a watermark. The result of the watermark detection is transmitted from the AV amplifier 20 to the DVD player 10 via the Consumer Electronics Control (CEC) protocol CEC line provided in the HDMI cable. In the DVD player 10, the HDMI unit 17 receives the result of the watermark detection and informs the system control unit 11 of the result. If the system control unit 11 has determined that the detected watermark is unauthorized, the HDMI unit 17 stops the bitstream output at this moment. If the AV amplifier 20 is of the type that also recognizes the AACS watermark application rule, the audio output of the decoding result is stopped at the time when the AV amplifier 20 determines that the detected watermark is unauthorized.

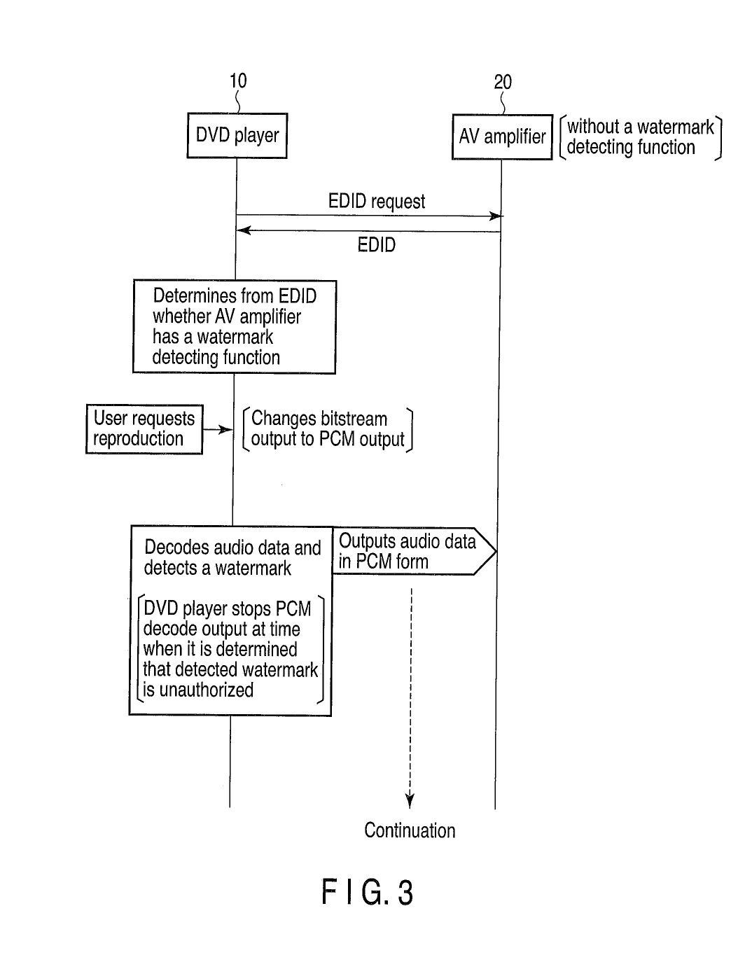

FIG. 3 shows the nature of the communication between the DVD player 10 and an AV amplifier 20 without a watermark detection function. When the AV amplifier 20 is connected to the DVD player with the HDMI cable, the DVD player 10 requests EDID from the AV amplifier 20, acquires EDID sent back from the AV amplifier 20 in return to the request, and determines from the EDID whether the AV amplifier 20 has a watermark detection function. When the user requests the reproduction of the audio data after it has been determined the AV amplifier 20 has no watermark detection function, the bitstream output from the DVD player 10 to the AV amplifier 20 is changed to a PCM output. Then, in the DVD player 10, the decode unit 16B decodes the audio data as needed and the watermark detection unit 16C detects a watermark. The watermark detection unit 16C informs the system control unit 11 of the result of the watermark detection. If the system control unit 11 has determined that the detected watermark is unauthorized, the decode unit 16B stops the PCM output at this moment.

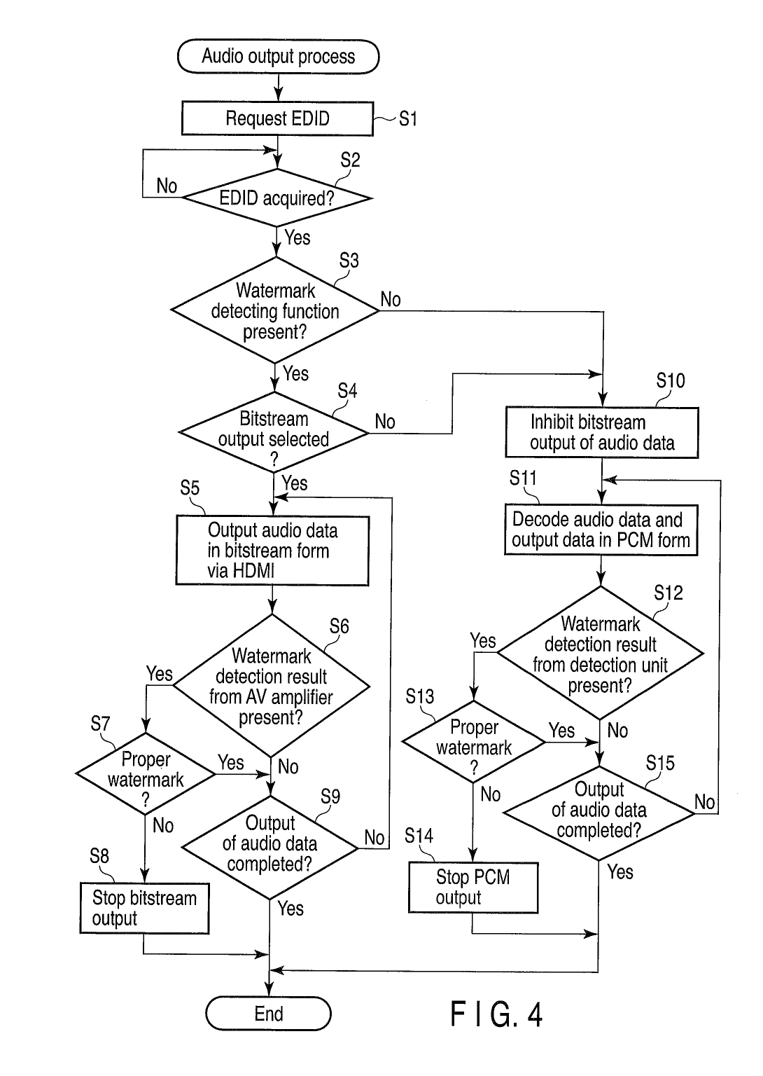

FIG. 4 is a flowchart to help explain an audio output process carried out by the system control unit 11. When the audio output process is started as a result of the connection of the AV amplifier 20, the system control unit 11 causes the HDMI unit 17 to request EDID from the AV amplifier 20 in step S1. In step S2, a check is made repeatedly to see if the EDID has been acquired. After the acquisition of the EDID, a check is made in step S3 if a watermark detection function is present. If it has been determined that a watermark detection function is present, a check is made in step S4 to see if the user has selected a bitstream output. If the bitstream output has been selected, the decode unit 16B is prevented from receiving the user's reproduction request in step S5 and the audio data is output in bitstream form to the AV amplifier 20 by way of the HDMI unit 17. Then, in step S6, a check is made to see if the result of the watermark detection from the AV amplifier 20 is present. If the result of the watermark detection is present, a check is made in step S7 to see if it is a proper watermark. If it is not a proper watermark, the bitstream output is stopped in step S8 and the audio output process is terminated.

If it is determined in step S6 that there is no watermark detection result, or if it is determined in step S7 that it is a proper watermark, a check is made in step S9 to see if the output of the audio data has been completed. If the output of the audio data has not been completed, step S5 is executed again to continue the output of the audio data. If the output of the audio data has been completed, the audio output process is terminated.

Furthermore, if it has been determined in step S3 that there is no watermark detection result or if it has been determined in step S4 that the bitstream output has not been selected, the audio data is inhibited from being output in bitstream form in response to the user's reproduction request in step S10. Then, in step S11, the decode unit 16B decodes the audio data and outputs the decoded data in PCM form to the AV amplifier 20. In step S12, a check is made to see if the watermark detection result from the watermark detection unit 16C is present. If the watermark detection result is present, a check is made in step S13 to see of it is a proper watermark. If it is not a proper watermark, the PCM output is stopped in step S14 and the audio output process is terminated.

Moreover, if it is determined in step S12 that there is no watermark detection result, or if it is determined in step S13 that it is a proper watermark, a check is made in step S15 to see if the output of the audio data has been completed. If the output of the audio data has not been completed, step S11 is executed again to continue the output of the audio data. If the output of the audio data has been completed, the audio output process is terminated.

In the embodiment, the DVD player is configured not to output the analog audio and the digital audio at the same time. Before the bitstream output of the audio data, specification identification data (EDID) is acquired from an external device, that is, the AV amplifier 20, and the watermark detection function of the external device is recognized on the basis of the specification identification data. Accordingly, since it can be left to the external device to perform decoding necessary to detect a watermark when the DVD player provides digital audio output, an inexpensive system can be constructed easily by reducing the load in processing audio data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An audio data processing apparatus comprising:
a selection unit which selects audio data to be reproduced under copyright protection;
a digital output interface unit which outputs the audio data selected by the selection unit in the form of a bitstream to an external device connected via a dedicated cable; and
a control unit which acquires specification identification data from the external device before the bitstream output of the audio data and recognizes a watermark detection function of the external device on the basis of the specification identification data.

2. The audio data processing apparatus according to claim 1, wherein the control unit acquires the result of detecting a watermark at the external device and stops the output of the audio data at the time when it is determined from the detection result that the watermark is unauthorized.

3. The audio data processing apparatus according to claim 1, further comprising:
a decode unit which decodes the audio data selected by the selection unit; and
a detection unit which detects a watermark from the result of decoding at the decode unit,
wherein the control unit, when having recognized the watermark detection function of the external device, halts the decode unit.

4. The audio data processing apparatus according to claim 3, wherein the control unit, if having failed to recognize the watermark detection function of the external device, acquires the result of detecting a watermark at the detection unit and stops the output of the audio data at the time when it is determined from the detection result that the watermark is unauthorized.

5. The audio data processing apparatus according to claim 3, wherein the selection unit, detection unit, digital output interface unit, and control unit are incorporated in a DVD player.

6. An audio data processing method of selecting audio data under copyright protection and causing a digital output interface unit to output the selected audio data in the form of a bitstream to an external device connected to the digital output interface unit via a dedicated cable, the audio data processing method comprising:
acquiring specification identification data from the external device before the bitstream output of the audio data and recognizing a watermark detection function of the external device on the basis of the specification identification data.

7. The audio data processing method according to claim 6, further comprising: acquiring the result of detecting a watermark at the external device and stopping the output of the audio data at the time when it is determined from the detection result that the watermark is unauthorized.

8. The audio data processing method according to claim 6, further comprising:
providing a decode unit which decodes the selected audio data and a detection unit which detects a watermark from the result of decoding at the decode unit, and
halting the decode unit, when having recognized the watermark detection function of the external device.

9. The audio data processing method according to claim 8, further comprising:
if having failed to recognize the watermark detection function of the external device, acquiring the result of detecting a watermark at the detection unit and stopping the output of the audio data at the time when it is determined from the detection result that the watermark is unauthorized.

10. The audio data processing method according to claim 8, wherein the decode unit, detection unit, and digital output interface unit are incorporated into a DVD player.
